(19) United States
(12) Patent Application Publication
(10) Pub. No.: US 2008/0298626 A1
(43) Pub. Date: Dec. 4, 2008

(54) AUDIO EARBUD CARRIER

(76) Inventor: Thomas M. DEAN, Hiram, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/191,141

(22) Filed: Aug. 13, 2008

Related U.S. Application Data
(63) Continuation-in-part of application No. PCT/US2007/062127, filed on Feb. 14, 2007.
(60) Provisional application No. 60/773,258, filed on Feb. 14, 2006.
(60) Provisional application No. 60/789,870, filed on Apr. 6, 2006.
(60) Provisional application No. 60/862,484, filed on Oct. 23, 2006.

(51) Int. Cl. H04R 25/00

(52) U.S. Cl. 381/381

(57) ABSTRACT

A flexible and compressible carrier includes a lobe having a receiver for releasably engaging an earbud-type audio earphone, and a retaining loop for securely positioning the lobe with the earphone adjacent the user's ear without insertion into the ear. User comfort, safety, and audio performance are enhanced, and the risk of hearing damage may be reduced.

### CROSS-REFERENCE TO RELATED APPLICATIONS

This application is a continuation-in-part of International PCT Application Serial No. PCT/US2007/062127, filed Feb. 14, 2007 and designating the United States, which claims the benefit of U.S. Provisional Patent Application Ser. No. 60/773,258, filed Feb. 14, 2006; U.S. Provisional Patent Application Ser. No. 60/789,870, filed Apr. 6, 2006; and U.S. Provisional Patent Application Ser. No. 60/862,484, filed Oct. 23, 2006, the entireties of which are all hereby incorporated herein by reference.

### BACKGROUND OF THE INVENTION

Earbud or ear-canal type audio earphones or speakers are commonly provided with MP3 players and other personal electronic audio devices. Such in-ear audio phones are typically inserted directly into the outer ear of the user, and held in place by contact between the ear and the earbud. These in-ear audio phones generally include a small cylindrical body containing an audio speaker, and configured for placement into the user's ear. A cord typically connects two such speaker bodies (one for each ear) to a jack for coupling to the audio source. Audio headsets incorporating one or more speakers mounted to a hard, flexible headband or ear clips are also known for use with a variety of audio devices.

It has been found, however, that in-ear audio phones are disfavored by many users due to discomfort, insecure placement in or on the ear, and/or concern over noise-induced hearing loss. For example, many known audio earphones or headsets function to position the speaker output within or directly against the entrance to the external auditory canal (the meatus auditorius externus), and/or retain the speaker in position by engagement on the outer ear (pinna or auricle) by light to moderate clamping or compression force against the tissue of the outer ear. Users of such devices may experience discomfort over extended or even moderate periods of use due to the pressure against the outer ear, and/or due to the presence of a foreign object in or against the auditory canal. In-ear devices that are positioned within the auditory canal tend to seal against the outer canal in a manner that prevents air circulation, which may add to the user's discomfort. Concerns have also been raised that the use of in-ear audio devices may contribute to hearing loss. Also, wearers may be less able to hear important external sounds such as traffic, warning signals or sirens, and the like, leading to safety concerns.

A further disadvantage to many known audio earphones or headsets results from the integration of the audio speaker with the ear clips, headband or other structure for retaining the speakers in position on the wearer's ears. A user wishing to replace or upgrade their audio earphones or headset typically replaces the entire assembly. In many instances, this is not particularly objectionable to the user because the product being replaced was as uncomfortable as its replacement. It would be desirable, however, to provide a comfortable carrier for universal application with a variety of audio earphone type speaker components, such that a user could replace or upgrade their audio earphones by means of interchangeable speaker components of universal compatibility with a common set of carriers.

Thus it can be seen that needs exist for improvements to audio devices, and in particular to improvements for earbud type audio headphones. It is to the provision of an improved audio device addressing these and other disadvantages that the present invention is primarily directed.

### SUMMARY OF THE INVENTION

The present invention provides a carrier for retaining an audio earbud or other audio output device on or adjacent a user's ear without insertion into the ear canal. The carrier is preferably formed entirely or substantially entirely of a soft, pliable and resilient material, providing enhanced user comfort and secure positioning of the earbud in relation to the ear. The carrier preferably includes a universal receiver for accepting and securely retaining any of a variety of earbud types, sizes, shapes and/or configurations. The carrier preferably includes an ergonomic loop portion retained on the user's ear without the use of spring-biased ear-clip or headband mechanisms, earlobe pinching means, or insertion into the ear canal. A pair of such audio earbud carriers can be provided in a set, one being generally a mirror image of the other, for use on the left and right ears of a user.

In one aspect, the invention is a carrier for an audio output device. The carrier preferably includes a lobe portion having a lower end, an upper end, an exterior face, and an interior face, the interior face defining a receiver for retaining an audio output device between the upper end and the lower end. The carrier preferably also includes a carrier loop having an upper loop portion extending from the upper end of the lobe portion, a medial loop portion extending from the upper loop portion for positioning behind an ear of a wearer, a lower loop portion extending from the medial loop portion, and a tail portion extending from the lower loop portion. Positioning the carrier loop over the ear of the wearer preferably positions the lobe portion over an auditory canal entrance of the ear without compression against or into the ear.

In another aspect, the invention is a carrier for an audio output device. The carrier preferably includes a lobe portion, means for positioning the lobe portion over an auditory canal entrance of a user's ear, and a receiver for repositionably retaining an audio output device therein. The carrier preferably is formed from a flexible and compressible material of construction.

In still another aspect, the invention is a carrier for an audio output device. The carrier preferably includes a lobe portion having a lower end, an upper end, an exterior face, and an interior face, and further including a receiver for retaining an audio output device between the upper end and the lower end, the receiver having a plurality of resilient keepers for engaging the audio output device therebetween. The carrier preferably also includes a carrier loop having an upper loop portion extending from the upper end of the lobe portion, a medial loop portion extending from the upper loop portion for positioning behind an ear of a wearer, a lower loop portion extending from the medial loop portion, and a tail portion extending from the lower loop portion. The upper loop portion is preferably thinner than the upper end of the lobe portion and also thinner than the medial loop portion, and the lower loop portion is preferably thinner than the medial loop portion and also thinner than the tail portion. The lobe portion and the carrier loop are preferably a one-piece molding formed from a compressible, low-durometer material. Positioning the carrier loop over the ear of the wearer preferably positions the lobe portion over an auditory canal entrance of the ear without compression against or into the ear.

In another aspect, the invention is a carrier for an audio earbud, the carrier including a retainer loop portion for securing the carrier to the ear of a user, and a receiver for engaging the audio earbud. In another aspect, the invention is the combination of an audio earbud and a carrier, the carrier including a lobe having a receiver for engaging the audio earbud therein and a retainer loop extending from the lobe for placement on the ear of a user. In another aspect, the invention is a carrier loop comprising a body having a contour for engaging one or more earbud carriers.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWING FIGURES

FIG. 1 is a first perspective view of an example form of the audio earbud carrier of the present invention.

FIG. 2 is a second perspective view of the audio earbud carrier of FIG. 1.

FIG. 3 is a side view of the audio earbud carrier of FIG. 1, as worn by a user.

FIGS. 4A and 4B are assembly views from the exterior side showing the positioning and retention of an audio earbud into engagement with the audio earbud carrier of FIG. 1.

FIGS. 5A and 5B show user insertion of an audio earbud into engagement with the audio earbud carrier of FIG. 1, shown from an interior side of the assembly.

FIGS. 6A and 6B are partial cross-sectional views (taken along the section lines indicated in FIG. 5B) showing the retention and positioning of an audio earbud in the audio earbud carrier of FIG. 1.

FIGS. 7 and 8 show a pair of audio earbud carriers in a cord-retaining carrier clip, according to another aspect of the invention.

FIG. 9 shows an audio earbud carrier according to an alternate embodiment of the present invention, being worn by a user.

FIG. 10 shows another alternate embodiment of an audio earbud carrier according to the present invention.

FIG. 11 shows an audio earbud carrier according to another alternate embodiment of the present invention.

FIGS. 12-14 show an audio earbud carrier according to another alternate embodiment of the present invention.

FIGS. 15 and 16 show interior and exterior views of an audio earbud carrier according to another alternate embodiment of the present invention.

FIG. 17 shows an audio earbud carrier according to another alternate embodiment of the present invention.

FIG. 18 shows an audio earbud carrier according to another alternate embodiment of the present invention.

FIG. 19 shows an assembly view of the audio earbud carrier of FIG. 18.

FIG. 20 shows a pair of audio earbud carriers according to another alternate embodiment of the present invention, worn by a user.

FIG. 21 shows a modified version of the pair of audio earbud carriers of FIG. 20, worn by a user.

FIG. 22 shows a pair of audio earbud carriers according to another alternate embodiment of the present invention, worn by a user.

FIGS. 23 and 24 show partial sectional views of an audio earbud carrier of the type shown in FIG. 22, in normal and compressed configurations, respectively.

FIG. 25 shows a pair of audio earbud carriers incorporated with eye-covers and attachment means for securing an audio player, according to another alternate embodiment of the present invention.

FIG. 26 shows a pair of audio earbud carriers according to another alternate embodiment of the present invention, worn by a user.

FIG. 27 shows a pair of audio earbud carriers incorporated with a headband according to another alternate embodiment of the present invention, worn by a user.

FIG. 28 shows a pair of audio earbud carriers incorporated with a headband carrying an audio output device according to another alternate embodiment of the present invention, worn by a user.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Also, it will be understood that unless otherwise indicated, dimensions and material characteristics stated herein are by way of example rather than limitation, and are for better understanding of sample embodiments of suitable utility, and variations outside of the stated values may also be within the scope of the invention depending upon the particular application.

Generally described, in example forms of the invention, a carrier or ear bud enclosure and retention loop provides much advancement over the use of ear bud and canal type headsets alone. Currently, there is no known product which is designed to retain ear bud type headsets to transform them into an ear clip type headset. The carrier or enclosure of the present invention preferably provides a user who receives an ear bud headset with the purchase of an MP3 player a choice to use the ear buds in an alternative way not currently available to the consumer. For consumers who dislike placing objects into or about their ear canal, the ear bud carrier device of the present invention enhances the value of the MP3 purchase because the user can make use of the ear bud phones which came with their MP3 device instead of feeling compelled to locate and purchase a second set of headphones. Many consumers dislike the feel and discomfort which can occur from the placement of objects within or about the ear canal. Specifically, the antitragus, external auditory meatus, tragus and intertragic notch portions of the ear may become tender after extended or even short periods of time with the placement of ear bud or canal type devices in this region of the ear.

Moreover, the use of an ear bud type speaker in connection with the carrier of the current invention positions and retains the speaker and surrounding portions of the carrier away from the surface of the wearer's ear causing little or no contact with the ear. This provides a comfortable listening experience more comparable to that of not wearing a headset at all and of listening from external speakers. The lightweight feature of the carrier device of the present invention enhances the pleasant listening experience because the wearer may become unaware of the presence of this device on their ears. And because the speaker is not inserted into the ear canal, the potential for hearing damage may be reduced.

Further, the enclosure or carrier is preferably manufactured of an extremely lightweight compressible, soft, pliable material such as but not limited to thermoplastic elastomers (TPE), polystyrene, expanded polypropylene (EPP), urethane rubber, silicone, closed cell cross linked PolyCell™, foam; etc. The carrier preferably comprises a carrier loop portion for placement over and around the back of the user's ear, and a lobe portion extending from the loop portion and over the front of the ear. The lobe portion preferably includes a receiver for engaging an ear bud type audiophone therein, and retaining the speaker of the earbud over or in the vicinity of the entrance to the ear canal. The shape design of the loop portion of the carrier in combination with the material properties of soft compression and surface coefficient of friction, and the weight balance between the clip and lobe portion of the carrier provide for a comfortable and superior securing of the carrier of the present invention on the wearer's ear without the use of biased headbands or ear-clips comprising multiple moving parts such as spring-biased clips or hard plastic clips that pinch the ear lobe or outer ear between the speaker portion of a device and its ear clip. The loop portion of the carrier is preferably smoothly contoured for comfort, and configured with a size and shape to be securely retained on the ear of a human user of average size and features.

While some previously known “hybrid” ear bud devices attempt to provide a more “secure” fit by employing the use of ear clips, they are generally disfavored in that they still rely on securing the fit of the headset by combining the insertion of the ear bud speaker into the concha region of the ear, with the ear clip simply wrapping over the top of the ear and preventing it from falling off the ear lobe. This may provide an adequate method for preventing the ear bud from falling off a wearer's ear, but generally fails to overcome the discomfort often associated with the use of ear buds.

The one-piece integral construction of the ear bud carrier or enclosure of the present invention may be manufactured using a two-part straight pull mold, which produces the product in a single part. Because the ear bud carrier or enclosure of the present invention is constructed of a single part for each ear, tooling and manufacturing costs can be minimized and there is no cost associated with product subcomponent assembly as in many previously known headsets. A preferred method of manufacturing is injection molding, however, pressure formed thermoforming, stamping or vacuum forming may also be employed to produce various forms of audio earbud carrier according to the present invention.

The ear bud enclosure or carrier of the present invention preferably includes a universal bud receiver compatible with a variety of ear bud types. Therefore, the wearer may upgrade or replace an old ear bud speaker with a new ear bud or an ear bud of a different stem and/or bud design and use many of them interchangeably with the universal carrier of the present invention.

The consumer market for headsets, whether they are for ear bud types, canal types, or can type conventional headphones is vast. An important and common marketing aspect in the industry is comfort and fit. An equally important factor is sound quality. Consumers may invest in a number of ear bud type headsets before finding one that suits his/her audio quality needs and one that also feels comfortable. With ear bud interchangeability, the carrier of the present invention provides the consumer the ability to make their purchasing decision on sound quality alone.

The carrier of the present invention may be used in connection with headsets for MP3 players or audio playback devices such as DVD players, video game consoles, headsets for cell phones, and various other audio devices. Moreover, the use of single-part soft-body headsets can be employed in the manufacture of headset devices wherein the speaker device is incorporated into the carrier and sold as one product. This advancement makes it possible for the soft body manufacture of other devices such as wireless headsets for MP3, telephones and cell phones.

The ear bud speaker is received into the device at the “bud receiver”. The components of example forms of the bud receiver include, from outside to the inside: a region for accepting ear buds with tapered stems which may also form into a tapered bud, a spherical region for receiving the bud speaker, a retaining means for preventing the ear bud from falling out of the device and an acoustical horn region to extend and direct sound waves toward the wearer's ear canal. The ear bud stem is received into the device at the “bud receiver stem channel”. Components of example forms of the stem channel include a channel with one straight side and an opposite tapered side. These provide for receiving stems that may either be straight or tapered. In addition, the placement of the stem channel is preferably offset from the centerline of the bud speaker. This is required to accommodate ear bud headsets, which are manufactured with an offset stem. In order to also accommodate stems (straight or tapered) which are centered with the bud speaker centerline, space is preferably provided for the over rotation of the stem within the stem channel up to or about 7 degrees. A “stem termination space” is preferably provided for ear buds whose stems protrude or extend beyond the point where the bud speaker curves away from point of attachment between the stem and the bud speaker. Alternative designs employing the assembly and joining of separate loop and lobe component portions are also within the scope of the invention, providing for the design of soft body devices, which require specialized features such as advanced external sound isolation.

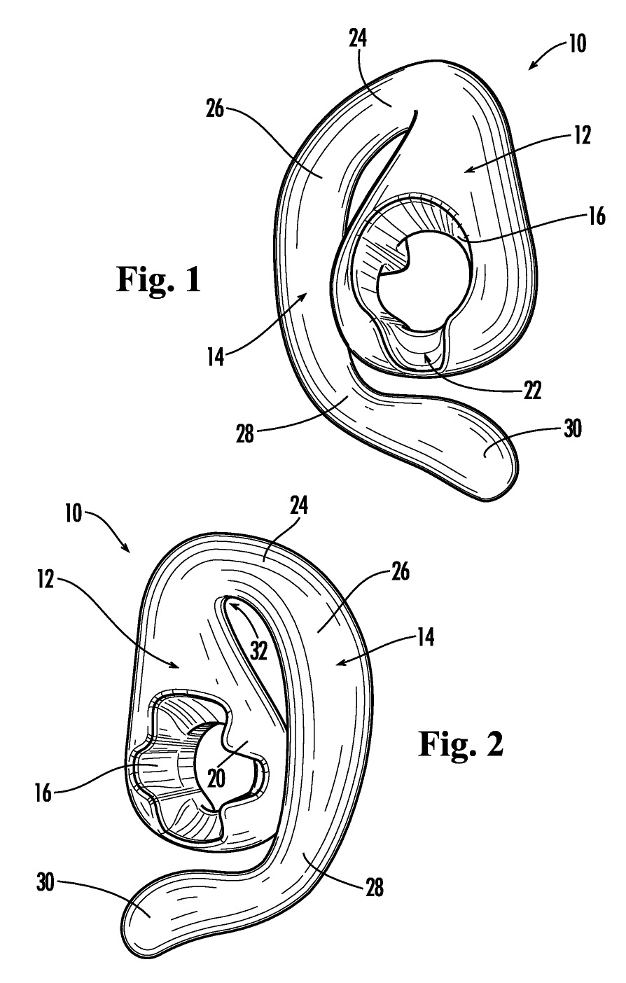

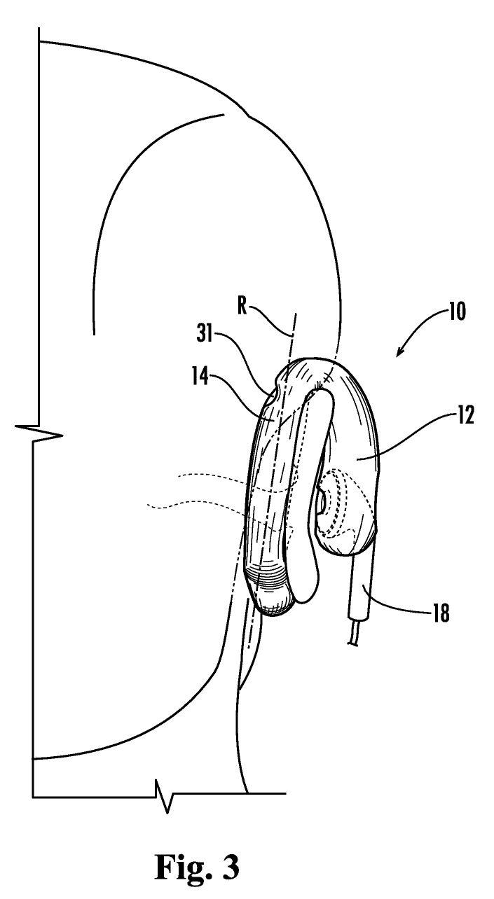

Example embodiments of the audio earbud carrier of the present invention will now be described with reference to the drawing figures. FIGS. 1-6 depict a first example form of the invention. An audio earbud carrier 10 generally comprises a lobe portion 12 and a carrier loop portion 14. As shown in FIG. 3, the carrier 10 is worn with the carrier loop 14 positioned behind the wearer's ear, and snugly engaged between the posterior auricle of the ear and the head and neck area behind the wearer's ear. In example applications, a first carrier 10 is configured to be worn on the wearer's right ear, and a second carrier that is substantially a mirror image of the first is configured to be worn on the wearer's left ear. As seen best in FIG. 3, the lobe portion 12 is laterally offset a distance from a reference plane R bisecting the length of the carrier loop portion 14. In this manner, the lobe portion 12 is preferably held in position over the entrance to the auditory canal, but spaced a small distance away from (for example, less than 5 mm) or only lightly touching the outer ear. Because the lobe portion is not compressed against or into the wearer's ear, improved comfort may be provided. Also, greater user safety may result due to a better ability to hear outside sounds, and/or a reduced likelihood of hearing loss which may result from intra-ear canal earphone usage.

The external surface of the lobe portion 12 is preferably smoothly contoured from a narrower (for example, about 15 mm in thickness) neck portion at its upper end to a wider (for example, about 25-30 mm in thickness), freely depending lower end. The lower end of the lobe 12 preferably includes a receiver 16 comprising an orifice, channel, chamber, clip, fastener, and/or other form of engagement means for receiving and retaining an audio output element such as an audio earbud 18 of typical form. In example form, the receiver 16 is an opening of about 10-20 mm diameter or crosswise dimension, extending through the lobe from an exterior face (shown in FIG. 1) to an interior face (shown in FIG. 2).

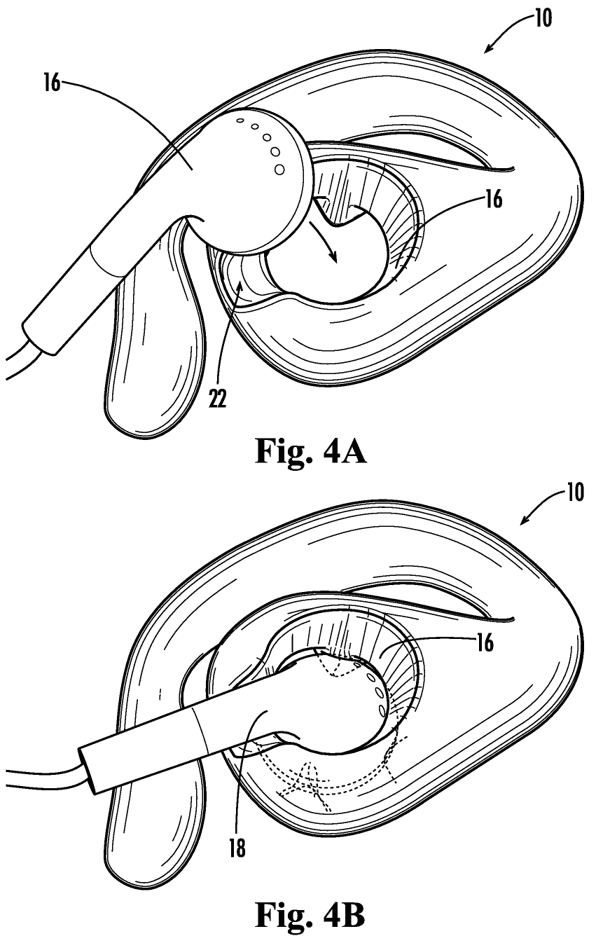

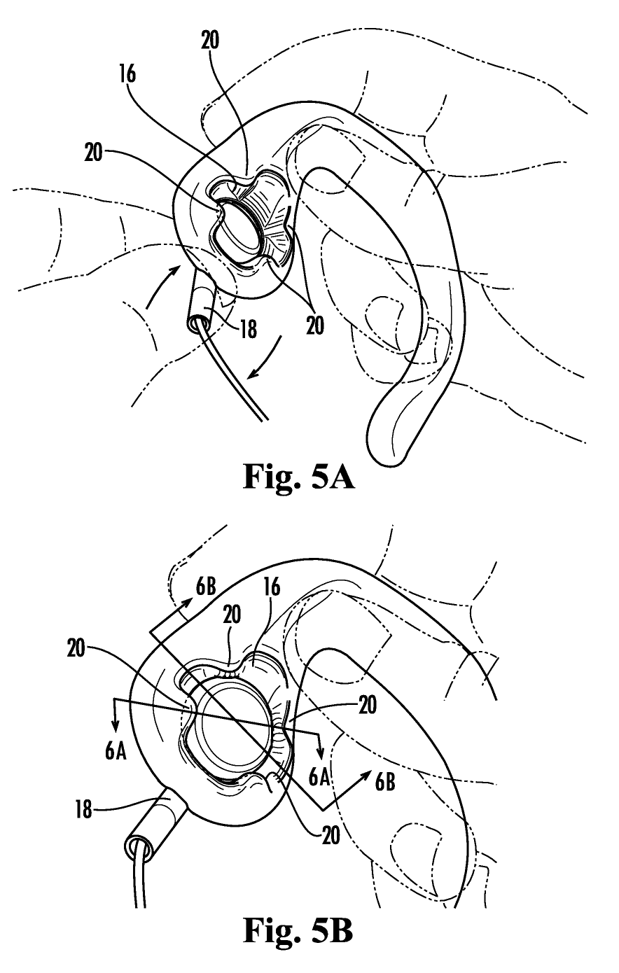

The receiver 16 optionally includes an irregular inner contour proximal the interior face, defining one or more inwardly-directed resilient fingers or keepers 20 for engaging the earbud 18 in a repositionable fashion. In the depicted embodiment, four inwardly-directed resilient keepers 20 are provided, defining a cruciate inner contour of the receiver 16 proximal its interior face. The inner contour of the receiver 16 proximal its exterior face preferably defines a generally circular, oval or elliptical channel having a radially outwardly extending slot or groove 22 for receiving the stem portion of an earbud, as seen best in FIGS. 4A and 4B. Assembly of an earbud 18 into the receiver 16 is shown in FIGS. 4A and 4B from the exterior side, and in FIGS. 5A and 5B from an interior side.

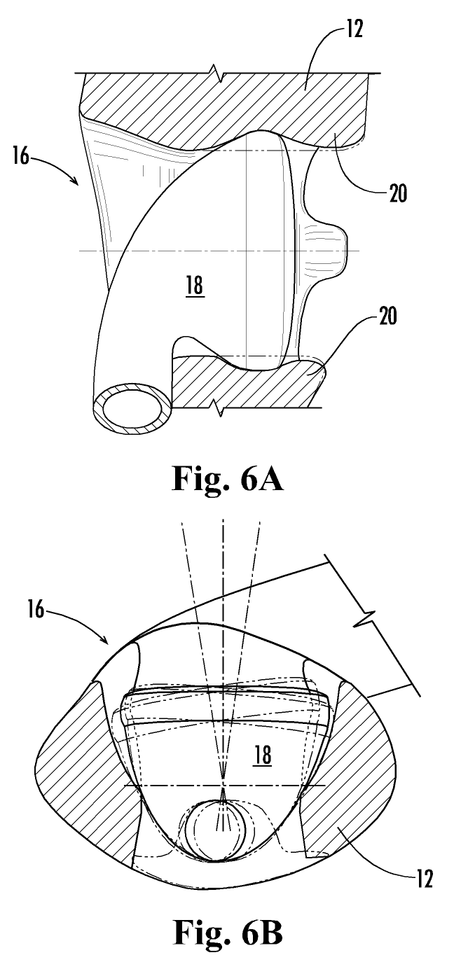

The material surrounding the receiver 16 is preferably sufficiently compressible and resilient to permit the speaker portion of the earbud 18 to be inserted through the receiver opening from the exterior side toward the interior side of the carrier 10. The internal dimension of the receiver is preferably progressively narrowing from the exterior side of the carrier toward the internal side, and proximal the interior side is preferably slightly less in its uncompressed state (shown by the broken lines in FIG. 6A) than the external dimension of the earbud's speaker portion. In this manner, insertion of the earbud compresses the inner surfaces of the receiver and/or the receiver's resilient keepers 20, to provide secure engagement of the earbud in the carrier. Preferably, a limited extent of relative motion is allowed between the earbud and the carrier (shown in broken lines in FIG. 6B), to permit adjustment of the location and angular orientation of the earbud for more secure engagement and for optimization of sound quality delivered to the user.

The carrier loop 14 extends from the upper end of the lobe 12, forming a continuous and smoothly curved elongate finger-like element. The carrier loop 14 preferably includes a relatively thinner (for example, about 12 mm in thickness) upper loop portion 24 providing a degree of flexure between the lobe 12 and the carrier loop 14, for better conforming to the shape of a wearer's ear to enhance comfort and provide secure retention of the carrier 10 in position on the wearer; a relatively thicker (for example, about 15 mm in thickness) medial loop portion 26, providing increased surface contact between the back of the ear and the head when worn (see FIG. 3) for enhanced positional retention; a relatively thinner (for example, about 10 mm in thickness) lower loop portion 28, providing flexibility for better conforming to the wearer's ear for comfort and retention purposes; and a relatively thicker (for example, about 14 mm in thickness) free end or tail portion 30, for surface contact between the wearer's earlobe and the head or neck behind the earlobe. The outer top surface of at least the upper loop portion 24 of the carrier loop 14 optionally comprises a groove or slot 31 for receiving the earpiece of a pair of eyeglasses or sunglasses worn by the wearer of the carrier 10.

The carrier 10 is preferably a unitary integral body, the lobe 12 and the carrier loop 14, for example, being formed as a single one-piece molding. The carrier 10 is preferably formed of thermoplastic elastomer (TPE), polystyrene, expanded polypropylene (EPP), urethane rubber, silicone, closed cell cross linked PolyCell™, foam, or other soft, flexible material(s) of construction. In example forms, the carrier 10 is formed as a low-cost, straight-pull single-piece molding without undercuts, for economy of manufacture. The material of the carrier 10 preferably has a low durometer hardness, for example, less than about 50-55, more preferably less than about 45, and most preferably between 35-45, on the Shore A scale. A relatively high coefficient of friction between the carrier 10 and the skin of a typical human wearer (both wet and dry) is preferably provided by appropriate selection of the material of construction and the surface finish. The overall mass of the carrier loop 14 is preferably approximately equal to or slightly greater than the overall mass of the lobe 12, such that a balancing point occurs at or near the internal apex 32 formed at the point of connection between the carrier loop and the lobe. The flexible and compressible nature of the carrier 10, its low hardness and high coefficient of friction, and the balanced mass of the lobe and loop portions, combine to provide for stable and comfortable retention of the carrier in position on a wearer during use, without the requirement for insertion into the ear or compression or pinching of the ear, even during very active use such as aerobic exercise, running, jogging, sports, activities, etc.

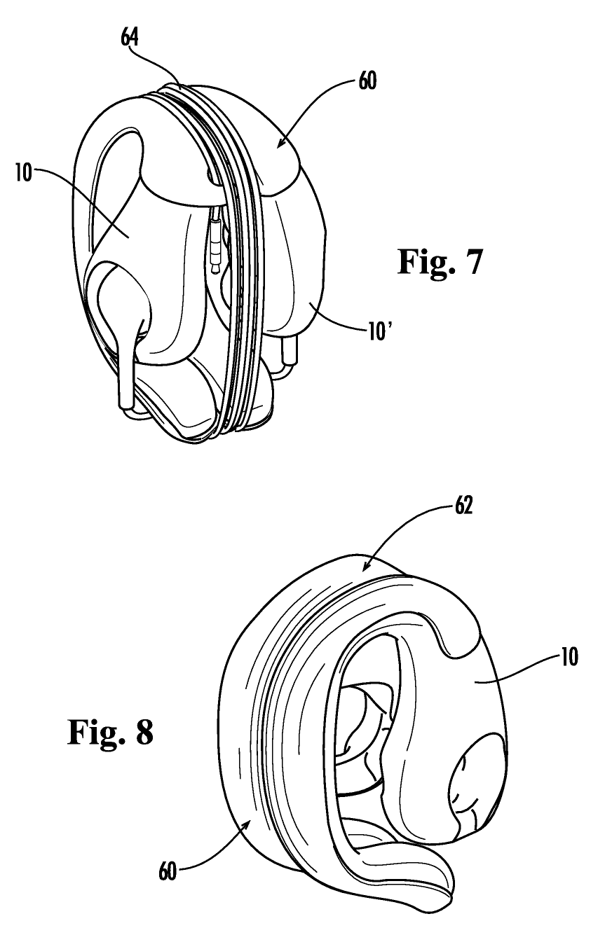

The invention optionally also includes a carrier clip 60, as shown in FIGS. 7 and 8, for receiving one or more (typically a left and right pair) earbud carriers 10, 10′ substantially as described herein. The carrier clip 60 is preferably a generally C-shaped member. The internal contour of the carrier clip 60 preferably receives the carriers 10, 10′ under a small degree of compression, to retain the carriers therein. The outer periphery of the carrier clip 60 preferably includes a recess or channel 62, within which the cords 64 of the earbuds 18 can be wrapped about, to prevent tangling of the cord during storage.

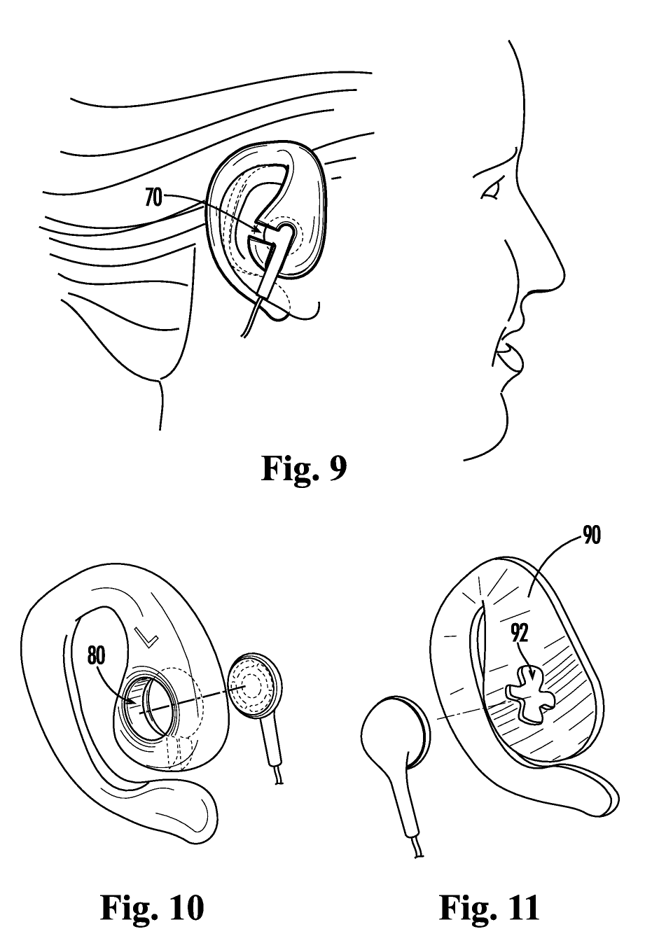

FIGS. 9-11 show several alternate embodiments of audio earbud carriers according to the present invention, similar to the above-described embodiment. In the embodiment of FIG. 9, the lobe of the carrier includes a slot 70 extending into the receiver, to facilitate insertion of the earbud. The embodiment of FIG. 10 omits the resilient keepers of the above-described embodiment, providing engagement of the earbud within a circular receiver 80 by means of a progressively narrowing receiver opening and/or by the resilience of the surrounding lobe material. The embodiment of FIG. 11 is formed as a generally flat panel of material 90 comprising lobe and retaining loop portions, as for example could be fabricated by stamping, and includes a cross-shaped receiver 92 in the lobe portion thereof.

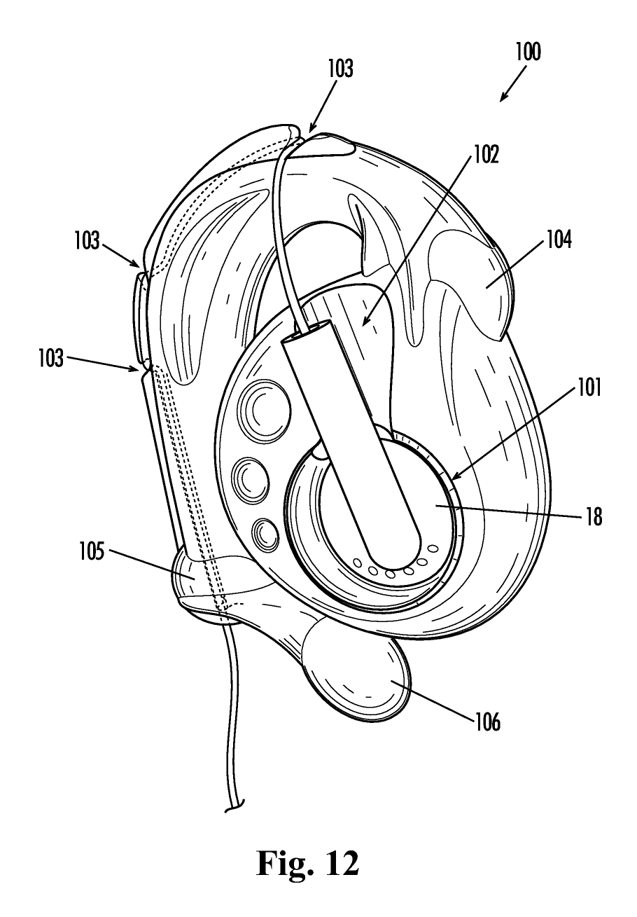

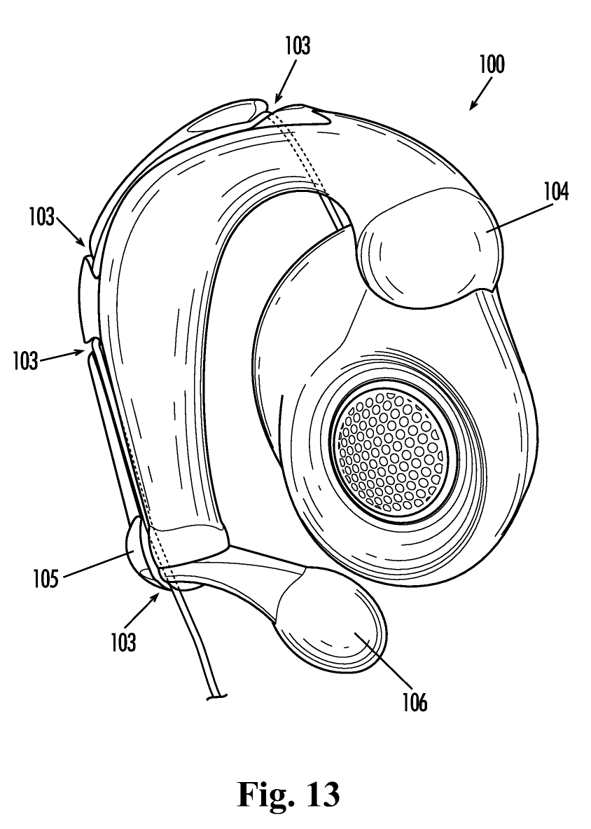

FIGS. 12-14 show another alternate embodiment of audio earbud carrier 100 according to the present invention. The carriers are optionally provided in pairs or sets as shown in FIG. 14, with each pair or set comprising a left carrier 100a and a right carrier 100b that are substantially mirror images of one another, adapted for wearing on the user's left and right ears, respectively. In this embodiment, the receiver opening 101 is inverted relative to the previously described embodiments, with the earbud stem channel 102 extending upwardly from a top portion of the receiver, for mounting the earbud 18 in the lobe of the carrier with its stem directed toward the upper loop portion of the carrier 100. The carrier 100 comprises a channel and/or a series of cable keepers 103 extending at least partially around the loop portion of the carrier, for receiving and engaging the earbud cable. In example forms, the channel or cable keepers 103 comprise tapered recesses and/or resilient members adapted to grip the earbud cable in compression to secure the cable to the carrier, and are optionally arranged in staggered offset alignment to allow the cable to be interwoven between successive keepers for a more secure attachment. One or more expanded bulb portions 104, 105, 106 are optionally provided, for example at or around the transitions between the lobe and the upper loop portion, between the medial loop portion and the lower loop portion, and/or at the tail of the loop portion, respectively. The bulbs 104, 105, 106 preferably comprise resilient and compressible bodies having an expanded dimension relative to adjacent structure for contact with the ear of the wearer for a more stable fit. An integrated cord wrap is optionally formed by an upper depression 107 (optionally forming part of one of the cable keepers 103 or a space between adjacent cable keepers) on the upper loop portion of each carrier 100, and by a lower depression 108 (optionally formed between medial and lower bulb portions 105, 106) on the lower loop portion, whereby the earbud cables can be wrapped about one or a pair of carriers as shown in FIG. 14, to keep the pair of carriers together and/or to prevent tangling of the cables when not in use.

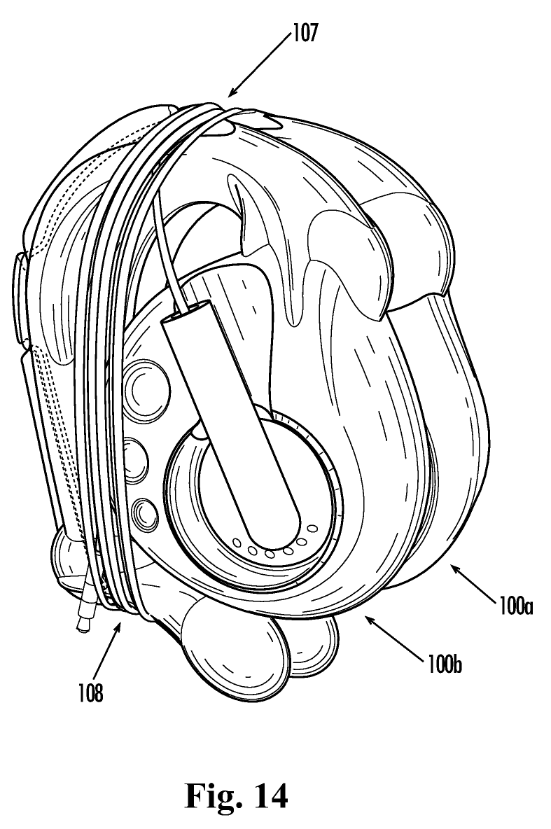

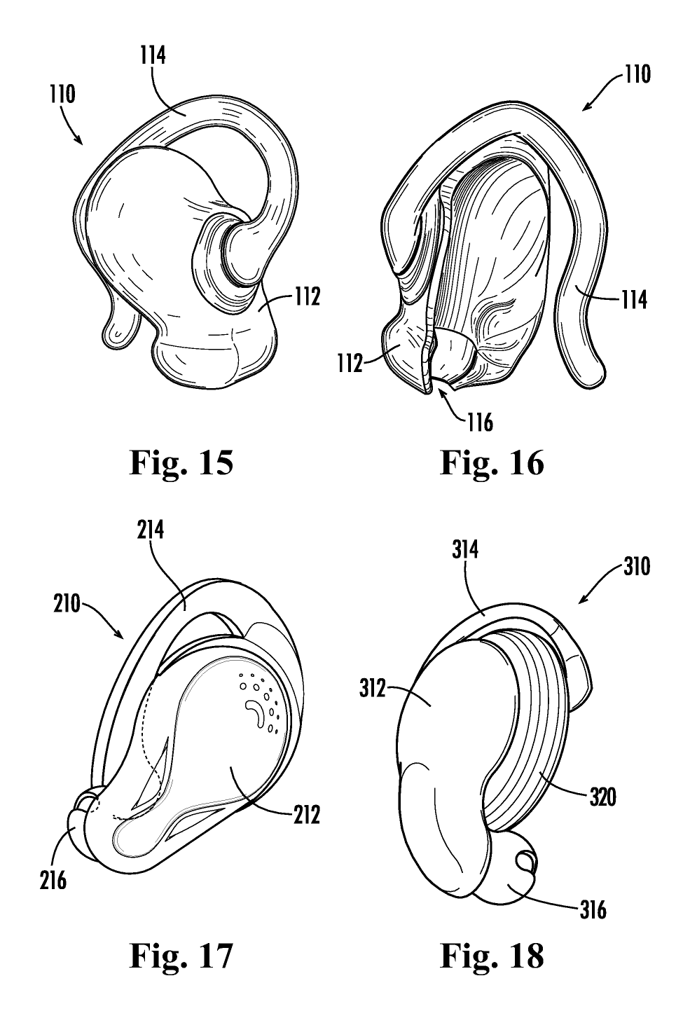

FIGS. 15 and 16 show an alternate embodiment of an audio earbud carrier 110 according to the present invention. The lobe portion 112 comprises a generally hollow shell configured to be placed over the outer ear of a wearer. The retaining loop portion 114 extends from the lobe 112, over and behind the wearer's ear, to secure the carrier 110 in position. The lobe 112 includes a receiver opening 116, for receiving and engaging an audio output element such as an audio earbud.

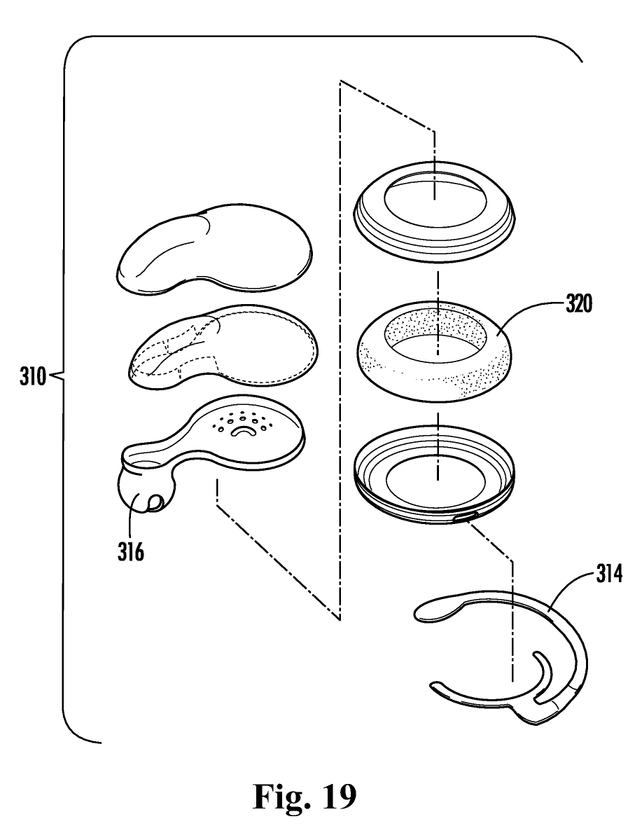

FIGS. 17, 18 and 19 show further alternate embodiments of audio earbud carriers 210, 310 according to the present invention. Outer shell portions of the lobe portions 212, 312, as well as the retaining loop portions 214, 314, preferably are formed of a harder, more rigid plastic material than the above-described embodiments. The receivers 216, 316 comprise generally spherical, hollow chambers having a slotted opening for receiving an audio output element such as an audio earbud. The embodiment of FIGS. 18 and 19 includes a soft, compressible pad portion 320, for example formed of an open-celled foam rubber, for light contact against the outer ear of a wearer.

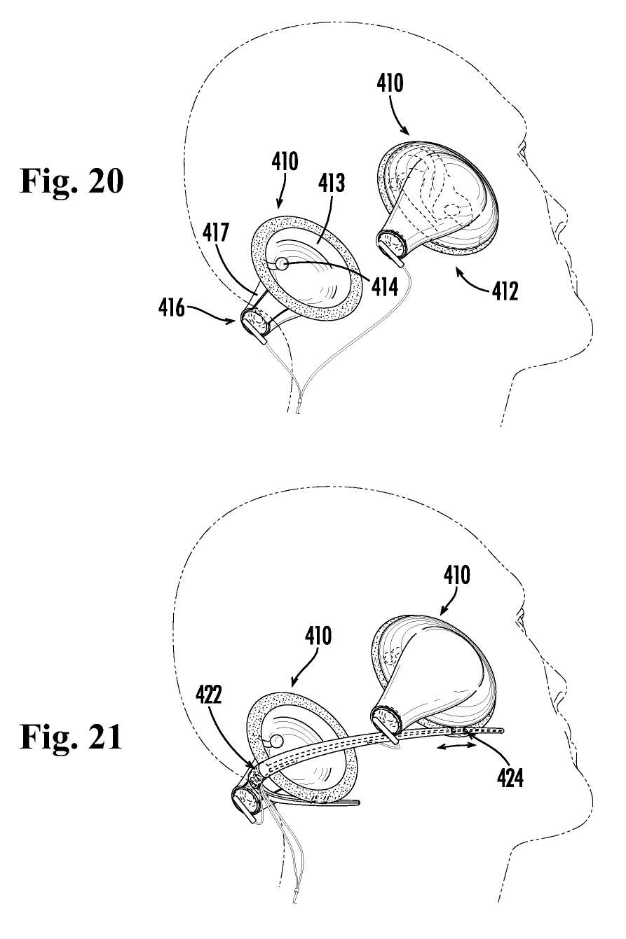

FIGS. 20 and 21 show additional alternate embodiments of audio earbud carriers 410 according to the present invention. The lobes 412 comprise generally horn-shaped bodies having cups 413 for placement over the outer ears of a wearer, extending toward receivers 416 positioned at the end of a tapered conduit 417 that is in internal communication with the cups for sound transmission from audio output elements retained in the receivers. One or more retaining members 414 are optionally provided within the interior of the cups 413 for securing the lobes 412 over the wearer's ears. In the embodiment of FIG. 18, a support band 420 connects first and second lobes for additional support of the lobes in position on the wearer, and optionally retains the earbud cables to prevent tangling. A flexible coupling 422 is preferably provided in a medial portion of the support band 420, to provide resilience and wearer comfort. An adjustable linkage 424 is optionally provided between the support band 420 and each of the lobe cups 413 to permit adjustment of the fit on a wearer.

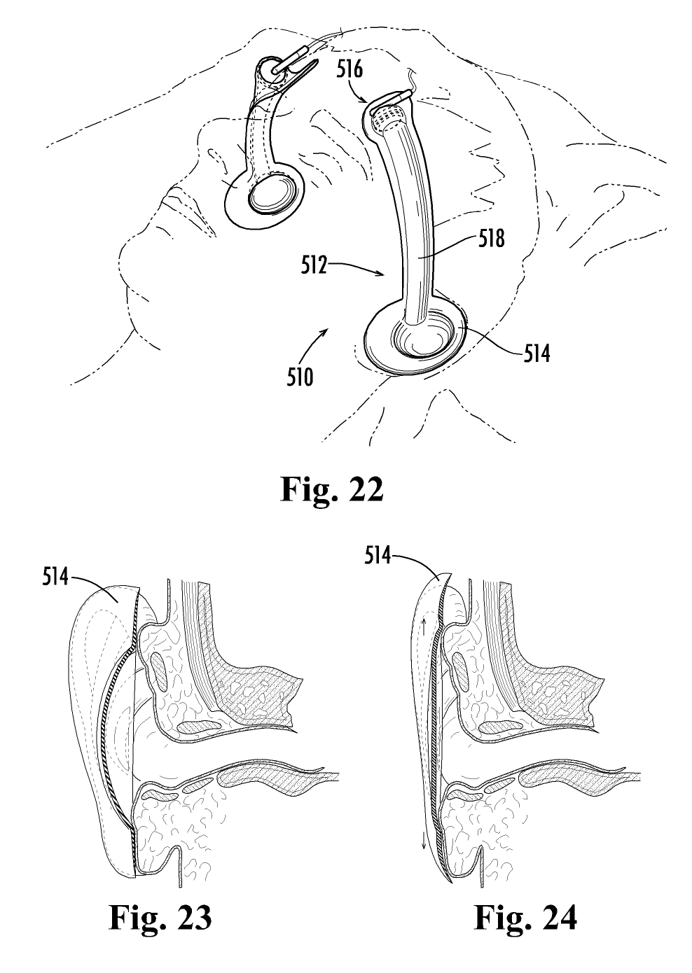

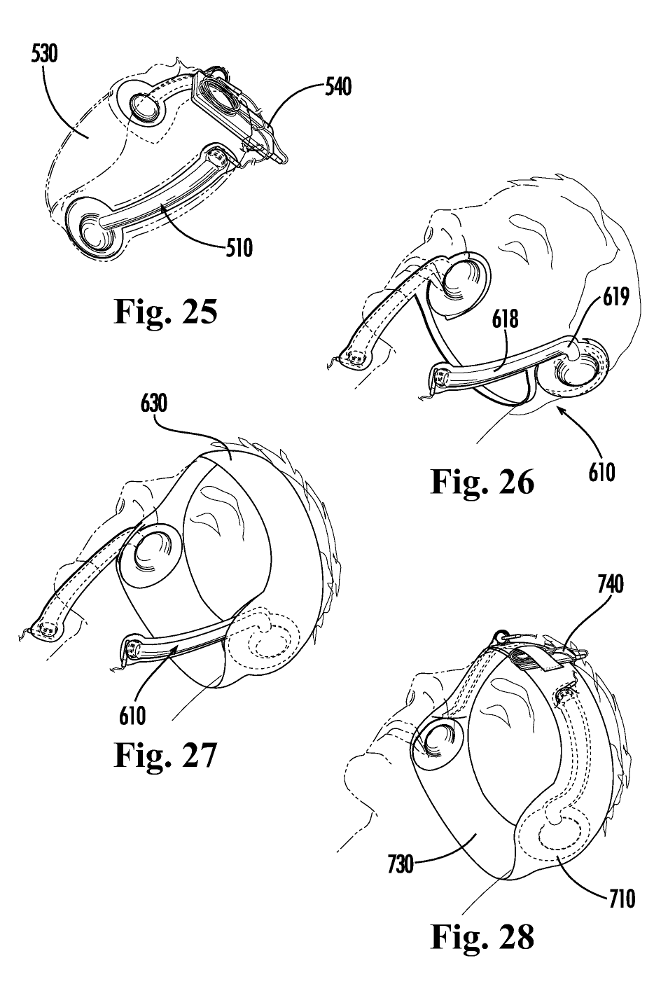

FIGS. 22-25 show further alternate embodiments of audio earbud carriers 510 according to the present invention. Lobes 512 of the carriers comprise earcups 514 for placement over the outer ears of a wearer. Receivers 516 for engaging audio output elements such as audio earbuds are positioned at distal ends of elongate, arcuate conduits 518 that are in open communication with the earcups 514 for sound transmission from the audio output elements. In preferred form, the earcups 514 and the conduits 518 are formed of flexible and compressible material(s), such that the carriers 510 may be worn comfortably while sleeping. In the event a wearer rolls over during sleep and compresses a carrier 510 from its normal state (FIG. 23) into a compressed state (FIG. 24), the earcups 514 will flatten somewhat, such that the carrier does not significantly effect the normal state of the cartilage and bone surrounding the wearer's ears, and sound transmission may still be communicated from the audio output element to the wearer. In the embodiment of FIG. 25, a pair of carriers 510 are mounted to a headband 530, optionally comprising eyeshades to help a wearer sleep, and coupling means for retaining an audio output device such as an MP3 player 540 thereon.

FIGS. 26 and 27 show alternate audio carriers 610 similar to the carrier 510 described above, but having laterally offset portions 619 of their sound-transmission conduits 618. The embodiment of FIG. 27 includes a headband 630 for positioning a pair of carriers on a wearer. FIG. 28 shows a similar arrangement including a headband 730 for retaining a pair of carriers 710 and an audio output device such as an MP3 player 740 thereon.

While the invention has been described with reference to preferred and example embodiments, it will be understood by those skilled in the art that a variety of modifications, additions and deletions are within the scope of the invention, as defined by the following claims.

What is claimed is:

1. A carrier for an audio output device, said carrier comprising:
a lobe portion having a lower end, an upper end, an exterior face, and an interior face, the interior face defining a receiver for retaining an audio output device between the upper end and the lower end; and
a carrier loop comprising an upper loop portion extending from the upper end of the lobe portion, a medial loop portion extending from the upper loop portion for positioning behind an ear of a wearer, a lower loop portion extending from the medial loop portion, and a tail portion extending from the lower loop portion;
wherein positioning the carrier loop over the ear of the wearer positions the lobe portion over an auditory canal entrance of the ear without compression against or into the ear.

2. The audio output device carrier of claim 1, wherein the lobe portion and the carrier loop comprise an integral unitary body.

3. The audio output device carrier of claim 2, wherein the integral unitary body comprises a one-piece molding.

4. The audio output device carrier of claim 3, wherein the one-piece molding comprises a compressible, low-durometer material.

5. The audio output device carrier of claim 4, wherein the low-durometer material has a Shore A hardness of less than 55.

6. The audio output device carrier of claim 4, wherein the low-durometer material has a Shore A hardness of less than 50.

7. The audio output device carrier of claim 4, wherein the low-durometer material has a Shore A hardness of less than 45.

8. The audio output device carrier of claim 4, wherein the low-durometer material has a Shore A hardness of between 35-45.

9. The audio output device carrier of claim 4, wherein the low-durometer material has a high coefficient of friction against the ear.

10. The audio output device carrier of claim 4, wherein the low-durometer material is selected from thermoplastic elastomer, polystyrene, expanded polypropylene, urethane rubber, silicone, closed cell cross linked PolyCell™, foam, and combinations thereof.

11. The audio output device carrier of claim 1, wherein the receiver comprises a progressively narrowing opening extending from the exterior face to the interior face.

12. The audio output device carrier of claim 11, wherein the receiver comprises a plurality of resilient keepers for engaging the audio output device.

13. The audio output device carrier of claim 1, wherein the receiver comprises an opening extending from the exterior face to the interior face, and further comprises at least three resilient keepers proximal the interior face for engaging the audio output device.

14. The audio output device carrier of claim 13, wherein the receiver comprises four resilient keepers defining a cruciate shaped opening at its interior face.

15. The audio output device carrier of claim 1, wherein positioning the carrier loop over the ear of the wearer positions the interior face of the lobe portion a distance away from an auditory canal entrance of the ear.

16. The audio output device carrier of claim 15, wherein positioning the carrier loop over the ear of the wearer positions the interior face of the lobe portion between 0.1 mm to 5 mm away from an auditory canal entrance of the ear.

17. The audio output device carrier of claim 1, wherein the upper loop portion is thinner than the upper end of the lobe portion and also thinner than the medial loop portion.

18. The audio output device carrier of claim 1, wherein the lower loop portion is thinner than the medial loop portion and also thinner than the tail portion.

19. The audio output device carrier of claim 1, wherein the exterior face of the lobe portion further comprises a groove extending from the receiver for accommodating a stem portion of the audio output device.

20. The audio output device carrier of claim 1, wherein the audio output device is an earbud audiophone.

21. In combination, a left-right pair of audio output device carriers according to claim 1, and a carrier clip having an internal contour for receiving the pair of audio output device carriers therein.

22. The combination of claim 21, wherein the carrier clip further comprises an outer periphery defining a recess for wrapping a cord of the audio output device thereabout.

23. The audio output device carrier of claim 1, wherein the carrier loop comprises one or more cable keepers for retaining a cable portion of the audio output device.

24. The audio output device carrier of claim 1, wherein the carrier loop comprises upper and lower depressions forming an integral cable wrap for securing a cable portion of the audio output device coiled thereabouts.

25. The audio output device carrier of claim 1, wherein the carrier loop comprises at least one expanded bulb portion.

26. A carrier for an audio output device, said carrier comprising a lobe portion, means for positioning the lobe portion over an auditory canal entrance of a user's ear, and a receiver for repositionably retaining an audio output device therein, wherein said carrier comprises a flexible and compressible material of construction.

27. The audio output device carrier of claim 26, wherein the flexible and compressible material of construction has a high coefficient of friction against the ear.

28. The audio output device carrier of claim 26, wherein the flexible and compressible material of construction is selected from thermoplastic elastomer, polystyrene, expanded polypropylene, urethane rubber, silicone, closed cell cross linked PolyCell™, foam, and combinations thereof.

29. The audio output device carrier of claim 26, wherein the receiver comprises an opening formed in the lobe portion of the carrier.

30. The audio output device carrier of claim 26, wherein the receiver comprises a plurality of resilient keepers for engaging the audio output device.

31. The audio output device carrier of claim 26, wherein the means for positioning the lobe portion over an auditory canal entrance of a user's ear comprises a carrier loop having an upper loop portion extending from an upper end of the lobe portion, a medial loop portion extending from the upper loop portion for positioning behind an ear of a wearer, a lower loop portion extending from the medial loop portion, and a tail portion extending from the lower loop portion.

32. The audio output device carrier of claim 26, wherein the lobe portion, the means for positioning the lobe portion over an auditory canal entrance of a user's ear, and the receiver comprise an integral unitary body.

33. A carrier for an audio output device, said carrier comprising:
a lobe portion having a lower end, an upper end, an exterior face, and an interior face, and further comprising a receiver for retaining an audio output device between the upper end and the lower end, the receiver comprising a plurality of resilient keepers for engaging the audio output device therebetween; and
a carrier loop comprising an upper loop portion extending from the upper end of the lobe portion, a medial loop portion extending from the upper loop portion for positioning behind an ear of a wearer, a lower loop portion extending from the medial loop portion, and a tail portion extending from the lower loop portion, wherein the upper loop portion is thinner than the upper end of the lobe portion and also thinner than the medial loop portion, and the lower loop portion is thinner than the medial loop portion and also thinner than the tail portion;
said lobe portion and said carrier loop comprising a one-piece molding formed from a compressible, low-durometer material;
and wherein positioning the carrier loop over the ear of the wearer positions the lobe portion over an auditory canal entrance of the ear without compression against or into the ear.
